(19) United States
(12) Patent Application Publication
(10) Pub. No.: US 2015/0294689 A1
(43) Pub. Date: Oct. 15, 2015

(54) MOTOR BASED FAILURE PREDICTION

(71) Applicant: Seagate Technology LLC, Cupertino, CA (US)

(72) Inventors: Suiwing Lawrence Leung, Chaska, MN (US); Timothy Edward Langlais, Minneapolis, MN (US)

(21) Appl. No.: 14/452,103

(22) Filed: Aug. 5, 2014

Related U.S. Application Data
(60) Provisional application No. 61/978,103, filed on Apr. 10, 2014.

(51) Int. Cl. G11B 27/36; G01M 13/00; G11B 33/14; G01L 5/00

(52) U.S. Cl. CPC G11B 27/36; G01L 5/00; G01M 13/00; G11B 33/148

(57) ABSTRACT

Provided herein is a method, including detecting a plurality of pieces of data associated with a motor and determining a percent drag change based on the plurality of pieces of data associated with the motor. The method further includes determining a failure prediction based on the percent drag change.

### RELATED U.S. APPLICATIONS

This application claims the benefit of U.S. Provisional Patent Application No. 61/978,103, entitled “MOTOR DRAG DETERMINATION”, filed Apr. 10, 2014, which is herein incorporated by reference.

### BACKGROUND

Motors, including fluid dynamic bearing (FDB) motors, have a number of different failure mechanisms. Some of the failure mechanisms may result in a change in the drag of the motor. For example, when an air bubble forms in the motor the drag of the motor decreases because the air bubble has a lower viscosity than the oil the air displaces. As another example, the oil may hydrolyze thereby creating a more viscous fluid with increased drag.

### SUMMARY

Provided herein is a method, including detecting a plurality of pieces of data associated with a motor and determining a percent drag change based on the plurality of pieces of data associated with the motor. The method further includes determining a failure prediction based on the percent drag change.

These and other features and aspects may be better understood with reference to the following drawings, description, and appended claims.

### DRAWINGS

FIG. 1 provides a flow chart of a process for predicting motor failure according to one aspect of the embodiments.

FIG. 2 provides a block diagram of an exemplary device and an analogy of the device for modeling according to one aspect of the embodiments.

FIG. 3 provides a flow chart of a process for determining a model for integral gain as a function of drag and temperature according to one aspect of the embodiments.

FIG. 4 provides graphs of integral gain, temperature, and percent drag change data of a motor according to one aspect of the embodiments.

FIG. 5 provides a flow chart of a process for determining whether a drag change is within a threshold according to one aspect of the embodiments.

FIG. 6 illustrates an exemplary diagram of a hard drive according to one aspect of the embodiments.

### DESCRIPTION

Before particular embodiments are described in greater detail, it should be understood by persons having ordinary skill in the art that the concepts presented herein are not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood by persons having ordinary skill in the art that the terminology used herein is for the purpose of describing particular embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps. For example, “first,” “second,” and “third” elements or steps need not necessarily appear in that order, and the elements or steps need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

Unless defined otherwise, all technical and scientific terms used herein have the same meaning as commonly understood by persons of ordinary skill in the art.

Motors (e.g., spindle motors of a hard disk drive (HDD)) with fluid dynamic bearings (FDB) can wear out due to a number of circumstances including, but not limited to, oil hydrolysis, lubricant evaporation, chemical reaction, surface metal-to-metal contact, and particles in the motor. For example, during oil hydrolysis water reacts with the oil and produces a thicker and more viscous fluid thereby increasing the drag. As another example, air ingestion or cavitation may cause FDB drag to decrease because less viscous air displaces oil in the motor. As another example, excessive wear particles may cause an increase in the viscosity of the fluid causing an increase in drag. Monitoring of changes in motor drag may thus be used to predict motor failure and thereby disk drive failure. Without monitoring of these changes, a motor (e.g., of a disk drive) may risk failure without warning.

Changes in motor circumstances or operating conditions may be monitored by changes in the drag of a motor. Several variables (e.g., servo variables available via SMART (Self-Monitoring, Analysis and Reporting Technology), described below) may provide a means to monitor bearing drag. Accordingly, the changes in the drag of a motor-based system may indicate an impending failure of the motor and thus the motor based system. Embodiments may thus use data (e.g., SMART data) to construct an in-drive measurement of drag that can be used to monitor the health of a motor (e.g., a FDB spindle motor).

Changes in the drag of a motor can be measured in a lab by measuring the amount of power required to spin the motor and comparing that amount of power to a previous measurement, which may come from the manufacturer, or a previous lab measurement. Also, a disk drive may be operated for a specified length of time while the current and energy required to run the motor are monitored. However, such measurements are taken in a precisely controlled environment with equipment external to the motor. For example, a current probe and a thermal chamber may be used. The precisely controlled environment accounts for drive variables including, for example, variations in temperature, supply voltage, the location of the heads, windage forces, etc.

However, motor systems may record data of various operating parameters. An onboard diagnostic system, e.g., a SMART system, may monitor the health of a disk drive by storing snapshots of key variables in an attempt to detect degradation that precedes failure. Provided herein are apparatuses and methods for using readily available data (e.g., SMART data) to closely estimate a motor's drag normalized for factors including, but not limited to, temperature, head location, etc. Particular embodiments will now be described in greater detail.

In some embodiments, the integral control parameter, K_{I}, is used. The integral control parameter K_{I} relates to the commanded motor current to the driver from the motor speed PI (proportional and integral) control loop. The adaptive gain on the integral control may be highly correlated with the motor's current. The integral control, K_{I}, may be stored in the SMART system. In some embodiments, the history of the integral control, K_{I}, is available as part of the SMART system data and may be used to determine the change in drag. The integral gain, K_{I}, based on being proportional to motor current may thus be used to monitor the motor current and thereby predict motor failure. It is noted that any value that is proportional to motor current may be used and thus embodiments are not limited to the integral gain, K_{I}.

In some embodiments, the integral control, K_{I}, can be expressed as a linear function of temperature, T, and drag, Dₘ:

K_{I}(T,Dₘ):=T·c₀+Dₘ·c₁+c₂

where c₀ is the slope of the temperature with respect to the adaptive gain (e.g., of K_{I}), c₁ is the slope of the drag with respect to the gain, c₂ is a constant offset, T is a measured temperature, and Dₘ is the drag of the motor.

In some embodiments, the coefficients c₀, c₁, and c₂ are determined for a particular device (e.g., disk drive).

The percent drag change may be expressed as:

$$Percent Drag change := \frac{( {K}_{I} - {K}_{I . initial} ) - ( T - {T}_{. initial} ) \cdot {c}_{0}}{{c}_{1}}$$

K_{I} is adaptive gain, K_{I.initial} is an initial gain, T is the temperature, and T_{.initial} is the initial temperature. c₀ may be determined by holding the motor speed constant and varying temperature. c₁ may be determined by holding temperature constant and varying the motor speed. c₂ may be a constant offset based on the actual geometry of the bearing and electromagnetic components of the motor. This constant offset will change from motor to motor but the slopes of temperature and spin drag (c₀ and c₁) do not change since the driver's response to changes in temperature and spin drag will not change from motor to motor.

The percentage drag change can thus be used to determine the health of the motor and detect failure modes that change the spin drag (e.g., hydrolysis, air ingestion, cavitation, etc.). For example, as a change in a motor's conditions increases the drag, the percent drag change can be used to determine if motor failure may be impending. Embodiments are configured to correlate temperature and adaptive gain to allow determination of drag change due to a change in viscosity. In some embodiments, the formula for drag for a particular drive is determined or configured to make drag insensitive to temperature change.

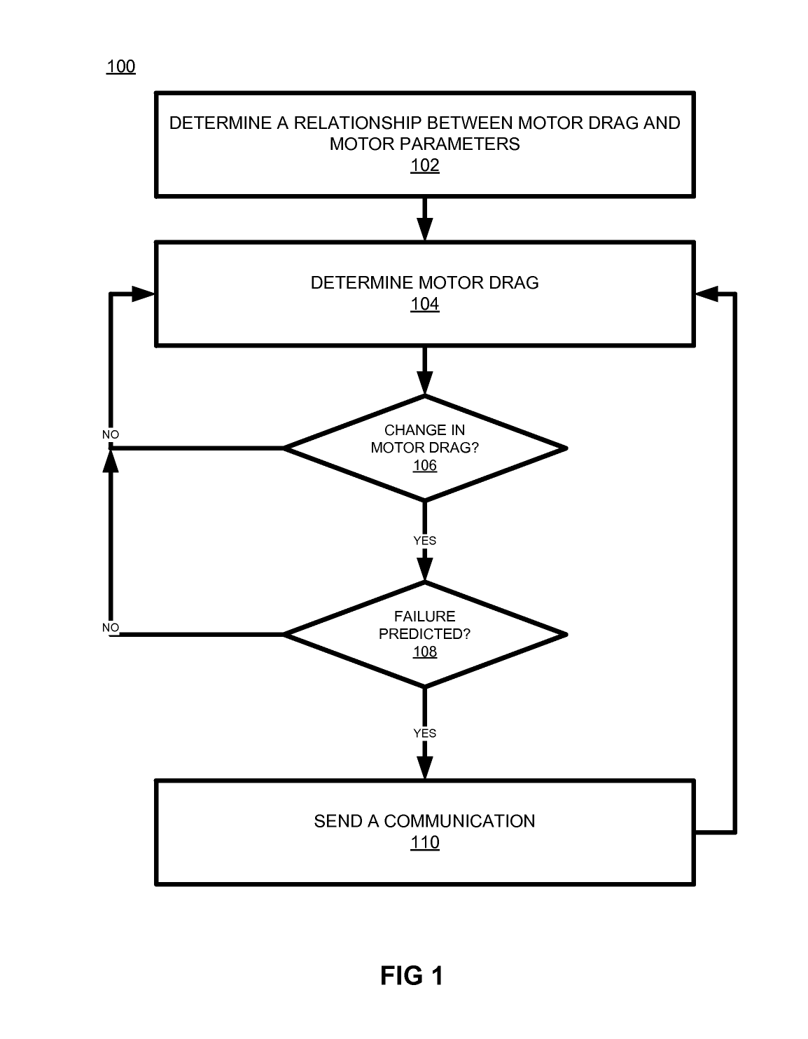

FIG. 1 provides a flow chart of a process for predicting motor failure according to one aspect of the embodiments. Flow chart 100 depicts a process for determining a relationship between motor drag and motor parameters and predicting failure based upon monitoring of motor drag.

At block 102, a relationship between motor drag and motor parameters is determined SMART provides a framework for monitoring key parameters of disk drive performance. In some embodiments, an empirical relationship between motor drag and parameters that can be stored in SMART (e.g., integral gain, K_{I}, T, etc.) in a controlled setting (e.g., laboratory). Drag may be used as a metric for determining the “health” of a motor. In some embodiments, a relationship is determined between motor control parameters and the motor run current or drag. It is appreciated that motor control functionality may or may not give access to the motor run current. The motor drag may therefore be determined based on motor control parameters.

In a motor, a proportional-integral (PI) control loop may be used to control the motor speed (e.g., in a brushless DC motor) as is used in disk drives. The proportional gain, Kₚ, and the integral gain, K_{I}, are adaptive parameters. In some embodiments, a relationship between the integral gain, K_{I}, and the motor run current is determined In some embodiments, a relationship between the proportional gain, Kₚ, or another motor parameter and the motor drag may be determined.

In some embodiments, the determining of a relationship with the drag (e.g., viscous drag) of the motor is based on controlling for factors that may include temperature, head location on the disk, altitude, etc. It is appreciated that the aforementioned factors may be hard to control when a motor is in operational use (e.g., in the field). Some embodiments may thus normalize the drag so that change in the drag reflects a change in the viscous drag of the motor. In other words, some embodiments may remove variation caused by other factors so that the remaining variation is from changes in drag (e.g., viscous drag). Some embodiments may thus control for factors that may vary during operation of the motor thereby allowing monitoring of variations in drag.

In some embodiments, the temperature effect can be included in the relation between the drag and integral gain, K_{I}. Some embodiments may support the inclusion of any factor in the relation that could change the run current for which there is an associated sensor (e.g., vibration, altitude, humidity, temperature, etc.).

Some embodiments are configured to detect and predict motor (e.g., fluid dynamic bearing (FDB) motor) failures during operation (e.g., in the field) based on a relationship between motor drag and motor parameters. The viscous drag (Dₘ) of the motor may be correlated with a number of failure modes. For example, air ingestion/cavitation causes the FDB drag to decrease because less viscous air displaces the oil in the motor. As another example, chemical reactions that change the oil viscosity (e.g., hydrolysis) can cause the FDB drag to increase as the viscosity of the FDB fluid increases. As another example, excessive wear particles cause an increase in the viscosity of the fluid causing an increase in drag. The viscous drag on the motor may be measured in the lab using run current (Iᵣᵤₙ) and constant supply voltage. The run current is related to the power needed to spin the motor at a given RPM (rotations per minute). In some embodiments, Iᵣᵤₙ is measured using a sense resistor on the motor driver or via a current probe on the motor phases.

In some embodiments, SMART may be used to store data (e.g., metrics) related to drive “health.” The data stored may be specific to a given drive manufacturer. The data may include measurements from in-drive sensors (e.g., atmospheric pressure, temperature, etc.) and may also include various servo-related parameters. A proportional-integral (PI) controller may be used to achieve servo control of the motor RPM. The gains of the proportional control (Kₚ) and the integral control (K_{I}) may be adaptive. The gains for the proportional control (Kₚ) and the integral control (K_{I}) may be stored in SMART along with other servo-related patterns. It is noted that integral control, K_{I}, is determined to be related to motor drag.

In some embodiments, factors that affect integral control, K_{I}, may be identified. The factors may include viscous drag of the motor (Dₘ), supply voltage (Vₛ), temperature (T), atmospheric pressure (Pₐ), windage drag (D_{w}), etc.

In some embodiments, the integral control, K_{I}, may be expressed as a function of the factors as:

K_{I}=ƒ(Dₘ,D_{w},V_{S},T, Pₐ, . . . )

Based on the identified factors, the function ƒ may be determined by varying the factors, e.g., Dₘ, D_{w}, V_{S}, T, Pₐ, . . . , and measuring K_{I}. The varying of the factors may result in a multi-dimensional surface. The function ƒ may then be linearized around the expected operating point (e.g., operating point during operations in the field) and the above equation solved for the motor drag (Dₘ). The motor drag, Dₘ, may be expressed as:

Dₘ=g(K_{I},D_{w},V_{S},T,Pₐ, . . . )

Dₘ=c₁+c₂*K_{I}+c₂*D_{w}, +c₃*V_{S}+c₄*T+c₅*Pₐ+

The Dₘ may then be collected and calculated in the field. In some embodiments, temperature, T, and atmospheric pressure, Pₐ, are measured using sensors (e.g., in a hard disk drive) and the measurements are stored in SMART. In some embodiments, c₃ is zero for a particular motor driver. In some embodiments, windage drag, D_{w}, may be assumed constant. Integral control, K_{I}, may be accessed via a motor driver controller and K_{I} may be stored in SMART. In some embodiments, based on the aforementioned values, Dₘ may be determined A Dₘ value may be stored (e.g., in SMART) as an initial motor drag value that is determined during manufacture and/or in a laboratory setting.

In some embodiments, during SMART frame save operations, Dₘ may be calculated and monitored over the life of the device (e.g., a hard disk drive). The frequency of the saves may be determined by the drive manufacturer and based on the workload of the device.

In some embodiments, the above mentioned procedure can be used to determine a change in other factors on which K_{I} is dependent if Dₘ is assumed constant or measured some other way in a device (e.g., hard disk drive). For example, the equation

Pₐ=h(K_{I},D_{w},V_{S},T,Dₘ, . . . )

may be used to determine altitude changes for a device without a pressure sensor.

At block 104, motor drag is determined. The procedure described above may be used to determine the motor drag during operation or the motor drag may be measured in some other way. The relation between the motor drag and the motor parameters may be used to normalize and calculate the motor drag during drive operation in the field. In some embodiments, the motor drag is accessed or calculated from SMART data. The motor drag during operation (e.g., in the field) may then be determined, normalized, and compared against a motor drag determined when the device was manufactured (e.g., a motor drag determined under laboratory settings in a manufacturing facility).

At block 106, whether a change in motor drag has occurred is determined In some embodiments, if there has been no change or substantially no change in the motor drag, the monitoring of the motor drag may continue (e.g., block 104). In some embodiments, a change in motor drag is determined based on comparing the normalized drag to a previous normalized drag. For example, the normalized drag during operation may be compared to the normalized drag determined during production of the drive (e.g., when the motor was at the factory or time t₀). If the motor drag has not substantially changed, block 104 may be performed. If the motor drag has changed, block 108 may be performed.

At block 108, whether failure is predicted based on the change in motor drag is determined A failure prediction may indicate whether a motor failure is imminent, a motor is likely to fail, a motor failure is not likely to occur, etc. In some embodiments, the change in drag may be compared against failure criteria. For example, the failure criteria may include monotonic increases or decreases over multiple measurements, number of excursions beyond a specified limit, etc. In some embodiments, the Dₘ values may be tested against failure criteria that may include a control chart approach with associated criteria, a moving average comparison with an initial value, a comparison of the current value of Dₘ to the initial value of Dₘ, a calculation of the first derivative of Dₘ to determine a change in the trend of Dₘ, etc. If failure is not predicted, block 104 may be performed. If failure is predicted, block 110 may be performed.

At block 110, a communication is sent. The communication may include a warning that motor or storage failure is imminent, impending, and/or predicted.

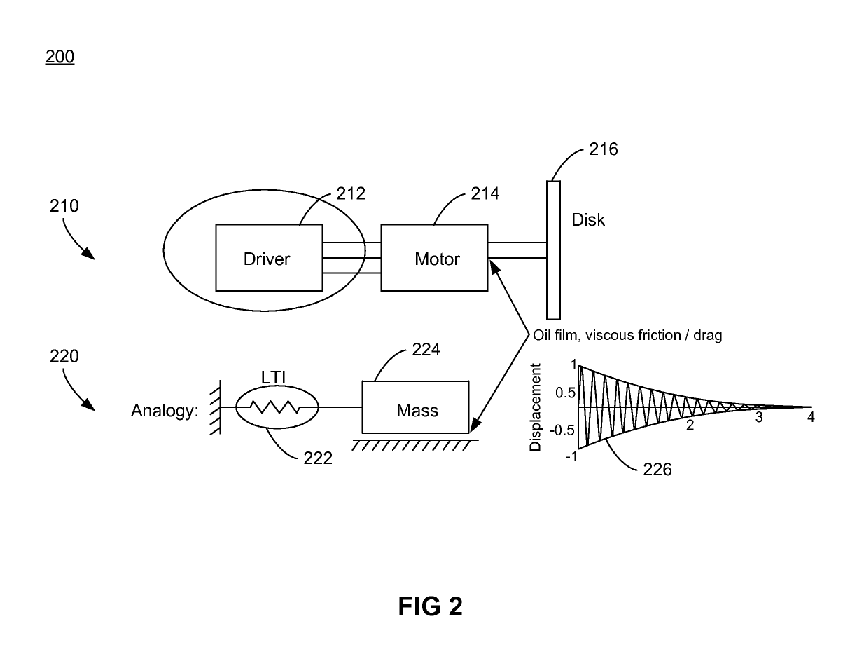

FIG. 2 provides a block diagram of an exemplary device and an analogy of the device for modeling purposes according to one aspect of the embodiments. FIG. 2 depicts an exemplary motor system and further depicts an associated analogy of the motor system. It is noted that the components, systems, and models are not limited to disk drives and can be applied to any system including a motor.

Exemplary motor system 210 includes a driver 212, a motor 214, and a disk 216. The driver 212 controls and provides current to the motor 214 in order for the motor 214 to rotate the disk 216. The disk 216 may be a storage medium (e.g., optical, magnetic, etc.) and represents a load to be rotated by motor 214. The motor 214 is in contact with an oil film having a viscous friction/drag, which may change over time. In some embodiments, the driver 212 may include a non-linear time-invariant (LTI) component 213.

In some embodiments, monitoring of a long-term motor mechanical property change based on electrical output from a driver is based on the driver's electrical system being linear time-invariant (LTI) (e.g., computed or modeled as LTI). For example, based on the selection of particular input and output variables of the motor driver, the driver may be treated as being LTI. Exemplary analogy system 220 includes a linear time-invariant spring 222 and a mass 224. In some embodiments, the exemplary analogy system 220 is used to model a system 210 and determine a steady-state response function of a motor current. In various embodiments, the linear time-invariant spring 222 corresponds to the driver 212 and the motor 214. The mass 224 may correspond to the disk 216 and rotatable portions of the motor 214, which are rotated via power provided to the motor 214. The mass 224 is in contact with an oil film having a viscous friction/drag, which may change over time.

FIG. 2 further includes a spring graph 226. In various embodiments, Kₚ and K_{I} changes are based on a spring constant not changing over the test time span. For example, ideally the spring is linear such that calculation can be simplified. For monitoring oil viscosity change in the motor based on measurement of the driver output, the driver's characteristics are treated as time invariant and the driver will respond linearly with respect to the change of motor drag and any related operating/environmental factors. The operating and environmental factors may include current (e.g., K_{I} servo variables that relate to the commanded current provided by the motor driver), power-on time, actuator arm position, drive depop configuration, drive temperature, and supply voltage. The factors can be used to model spin drag:

K_{I}=ƒ(T,Dₘ,V, number of discs, head position)

Some embodiments may thus find an appropriate set of driver operating parameters such that the driver operating parameters steady-state response due to spin drag change is linear. In some embodiments, motor drivers may be considered time-invariant since the motors are digital-analog mixed signal systems with minimal aging effect. The hard disk drive motors may have a power drive section and a few measurement sensors as analog components.

In some embodiments, the SMART data includes a value associated with motor current, proportional to motor current, or related to motor. This value may include K_{I} or Kₚ, which is captured by the SMART system on a fixed time interval. In various embodiments, K_{I} is measured when the heads of a disk drive are at the inner diameter. Thus, with K_{I} being measured when the heads are at the inner diameter each time, the data can be compared directly, and the actuator arm position (i.e., windage) is no longer a variable.

Based on the printed circuit board (PCB) 12V supply voltage being higher than a threshold voltage (e.g., 10.5V, etc.), the K_{I} may not be affected by supply voltage (e.g., based on experimental data). For example, based on experimental data, if the spin drag and temperature are held constant while the power supply voltage varies, K_{I} is constant as long as the power supply voltage is greater than the threshold voltage. This means that the supply voltage is no longer a variable of K_{I} and the power supply voltage may be dropped from the modeling function thereby reducing K_{I} function to two independent variables of spin drag and temperature.

In some embodiments, the testing data are based on differentials of initial and later values for the same hard disk drive. If test data is compared among the same hard drive configuration, then the disk drive configuration may not be a variable affecting test results. Based on these conditions, the model function can be reduced to:

K_{I}=ƒ(T,Dₘ)

In some embodiments, it can be shown (e.g., experimentally) that K_{I}=ƒ(T,Dₘ) slopes are linear in both temperature and drag directions. Based on the slopes of two directions being pre-determined statistically, the drag change calculation can be based on known initial K_{I} and temperature values and the spin drag change can be derived regardless of the temperatures at which K_{I} is measured.

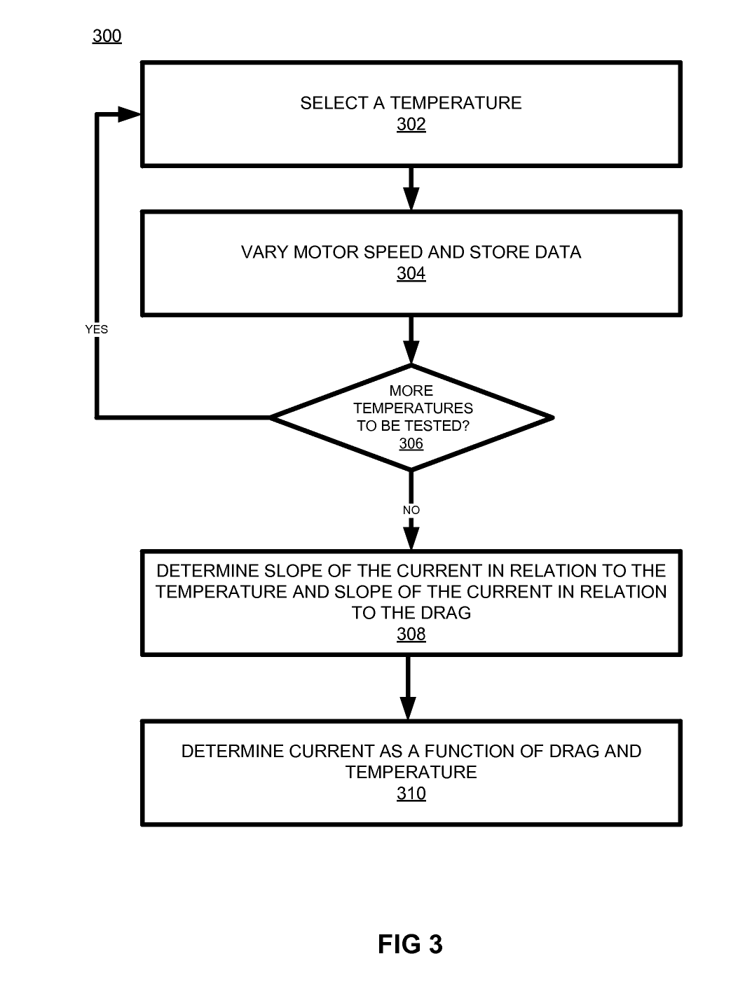

FIG. 3 provides a flow chart of a process for determining a model for integral gain (e.g., K_{I}) as a function of drag and temperature according to one aspect of the embodiments. FIG. 3 depicts a flow chart of a process for determining a steady-state response function of a motor current (e.g., based on K_{I}). Embodiments are not limited to disk drives and can be applied to any system including a motor.

At block 302, a temperature is selected. The temperature may be selected from a temperature range (e.g., a predetermined temperature range), as described herein. Additional values may be selected or determined for other factors including supply voltage (Vₛ), atmospheric pressure (Pₐ), windage drag (D_{w}), altitude, etc.

At block 304, the motor speed is varied at the selected temperature and associated data is stored. As described herein, a motor speed may be selected for measuring the drag of the motor. The data may include drag data, the associated temperature, and the associated current.

At block 306, whether more temperatures are to be tested is determined The temperature may be selected from a temperature range (e.g., a predetermined temperature range) to collect data for determining a steady-state response function for the current of the motor that is temperature insensitive. In some embodiments, the temperature may be varied from 5° C. to 16° C. or 4° C. to 64° C. (e.g., in 4° C. increments). If there are more temperatures to be tested, block 302 may be performed. If there are no more temperatures to be tested, block 308 may be performed.

At block 308, the slope of the current in relation to temperature is determined and the slope of the current in relation to the drag is determined The determination of the slope of the K_{I} in relation to temperature and the slope of the current in relation to drag may be based on solving a system of equations (e.g., simultaneous equations) based on a regression. In some embodiments, the data including current collected at the various temperatures and motor speeds is put into a linear regression model, as described herein, in order to determine the slope of the K_{I} in relation to temperature (e.g., c₀). The linear regression model may be based on a linear time-invariant model, as described herein.

In some embodiments, the data including current collected at the various temperatures and motor speeds is put into a linear regression model, as described herein, in order to determine the slope of the current in relation to drag (e.g., c₁). In various embodiments, the constant offset (e.g., c₂) is determined. The DC offset may be associated with the geometry of the bearing of the device. The linear regression model may be based on a linear time-invariant model. The slope of the current in relation to drag and the slope of the current in relation to the temperature may be determined at the beginning of manufacture of a disk drive (e.g., a particular model of disk drive) and may be stored in the disk drive (e.g., in firmware).

At block 310, the current as a function of drag and temperature is determined As described herein, the steady-state response function of the current may be determined In some embodiments, the function may be expressed as:

K_{I}(T,Dₘ):=T·c₀+Dₘ·c₁+c₂

as described herein. In some embodiments, testing procedures are used to determine a steady state response function.

The spin drag may be measured via varying motor spin speed. The range may be within +/−3% from the nominal spin speed, with a one percent increment. It is noted that spin drag change is substantially linearly proportional to the change in speed within this range.

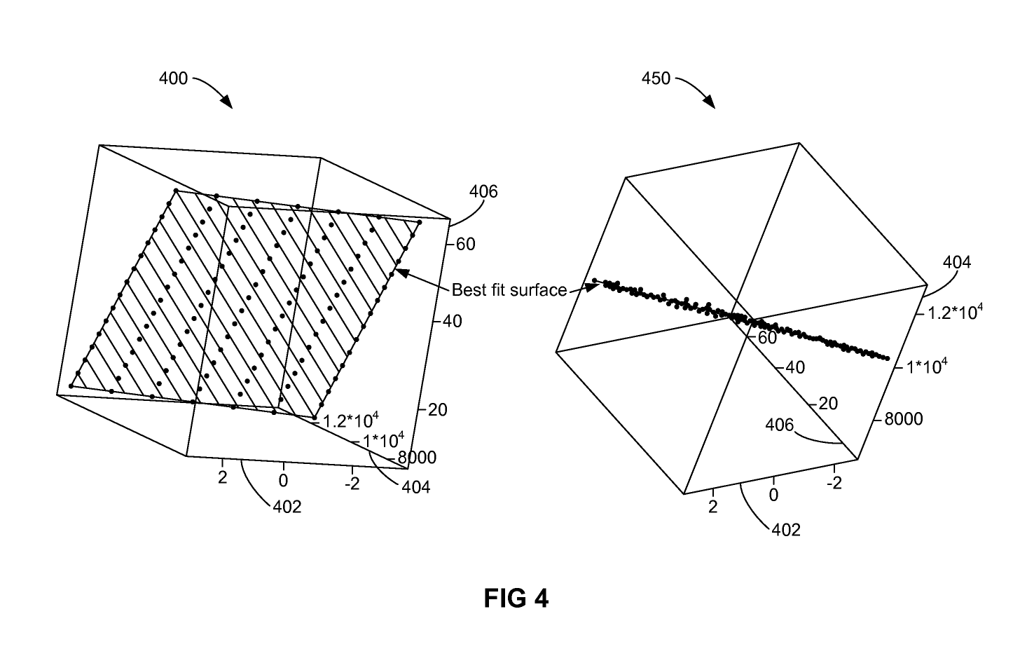

In various embodiments, at each temperature, the spin drag or speed is changed step-wise from −3% to +3% in 1% increments. Measurements are taken at each spin drag level. For example, the measurement data may include 16 temperature steps and 7 spin drag levels. The experimental data may then be fed into a multivariate regression routine to determine a steady-state response function (see e.g., FIG. 4).

FIG. 4 provides graphs of integral gain, temperature, and percent drag change data of a motor according to one aspect of the embodiments. FIG. 4 depicts graphs of data (e.g., experimentally collected from hard disk drives) of the K_{I}, temperature, and percent drag change and the corresponding best-fit surfaces.

Graph 400 depicts the data of current (e.g., K_{I}) percent drag change, and temperature. Percent drag change is represented on the X-axis 402. Temperature is represented on the Y-axis 406. Current (e.g., K_{I}) is represented on the Z-axis 404.

Graph 450 shows a best-fit surface of the data of the current, temperature, and percent drag change from a different perspective (e.g., rotated). Percent drag change is represented on the X-axis 402. Temperature is represented on the Y-axis 406. Current (e.g., K_{I}) is represented on the Z-axis 404.

In some embodiments, the multivariate regression is used to fit experimental data to a 3-variable linear model. The result may be a plane equation in 3D space:

K_{I}(T,Dₘ):=T·c₀+Dₘ·c₁30 c₂

where c₀ is the slope toward temperature direction, c₁ is the slope toward spin drag direction, and c₂ is the DC (direct current) offset (e.g., a constant term).

As shown in graphs 400 and 450, when the test data plot is viewed from an edge of the best fit surface, the data points are concentrated within a very narrow band which indicates that the experimental data matches the model shape and the model assumptions are valid. In some embodiments, for multiple drivers PCBAs (printed circuit board assemblies), standard deviation for the slope variation is very small. The mean coefficients (slopes) are parameters of the 3D plane equation. Collectively, these mean coefficients represent the general shape of a driver's steady state response function. In other words, the mean coefficients may represent the common characteristics of a large population of motor drivers.

In some embodiments, the motor spin drag change is determined from the SMART data. The change in motor spin drag can be calculated based on SMART data and coefficients of the response function because the each individual driver's steady-state response function is linear and can be inferred from a group of previously measured typical samples (e.g., due to the standard deviation being small). This may be expressed as:

$$Percent spin drag change = F ( Δ {K}_{I} , Δ T )$$

$$or \text{:}$$

$$Percent Drag change := \frac{( {K}_{I} - {K}_{I . initial} ) - ( T - {T}_{. initial} ) \cdot {c}_{1}}{{c}_{0}}$$

where (K_{I}−K_{I.initial}) is ΔK_{I} (e.g., associated with change in adaptive gain) and (T−T_{.initial}) is Δtemperature.

In some embodiments, the first data point in the SMART data is not included or skipped because the first data point may be higher than normal. There may be sudden changes in K_{I} caused by temperature. The fluctuation of the K_{I} data can be reduced by temperature compensation using temperature coefficient from response function.

In various embodiments, based on the measurement of a group of typical reference disk drives, K_{I} slopes (e.g., coefficients of the steady-state response function) can be statistically determined and may be used to estimate the change in spin drag (e.g., due to hydrolysis) of a sample drive independent of the temperature. In some embodiments, the general shape of the steady-state response function K_{I}=ƒ(T, Dₘ) is a plane in 3D space. A first order linear (plane) equation with 2 independent variables is adequate to relate K_{I}, temperature, and spin drag (e.g., Dₘ).

A linear equation of ΔPercent spin drag=F(ΔK_{I},ΔT) may be used to recover spin drag from SMART data. The SMART data may be used in conjunction with the driver's steady-state response function (e.g., based on the driver's common characteristics), which enables the plotting of the change of the motor spin drag vs. power-on time. This results in a trend line configured to show if the motor spin drag has changed over a certain time span.

In some embodiments, initial conditions of time, temperature, and K_{I} are used a starting reference point and embodiments may determine the relative change in spin drag. In various embodiments, driver electronics and motor electro-magnetic properties are treated as time-invariant. A new response function may be determined if there are changes in electronics, servo code, or motor electro-magnetic properties during a hard disk drive's production period.

Embodiments may include on-board motor condition monitoring. For example, steady-state response function coefficients can be pre-programmed into firmware (e.g., of a hard disk drive) for use in processing current data (e.g., K_{I} SMART data) to extract spin drag change history. The temperature effect of drag change may be normalized for (fair) comparison purposes. SMART data (e.g., K_{I}) may be used to flag or notify a user of abnormal spin load conditions when a pre-set level (e.g., threshold) is reached.

Embodiments may further be used with SMART data downloaded from a hard disk drive. For example, the steady-state response function coefficients can be applied to SMART data to diagnose motor load condition change (e.g., spin drag change).

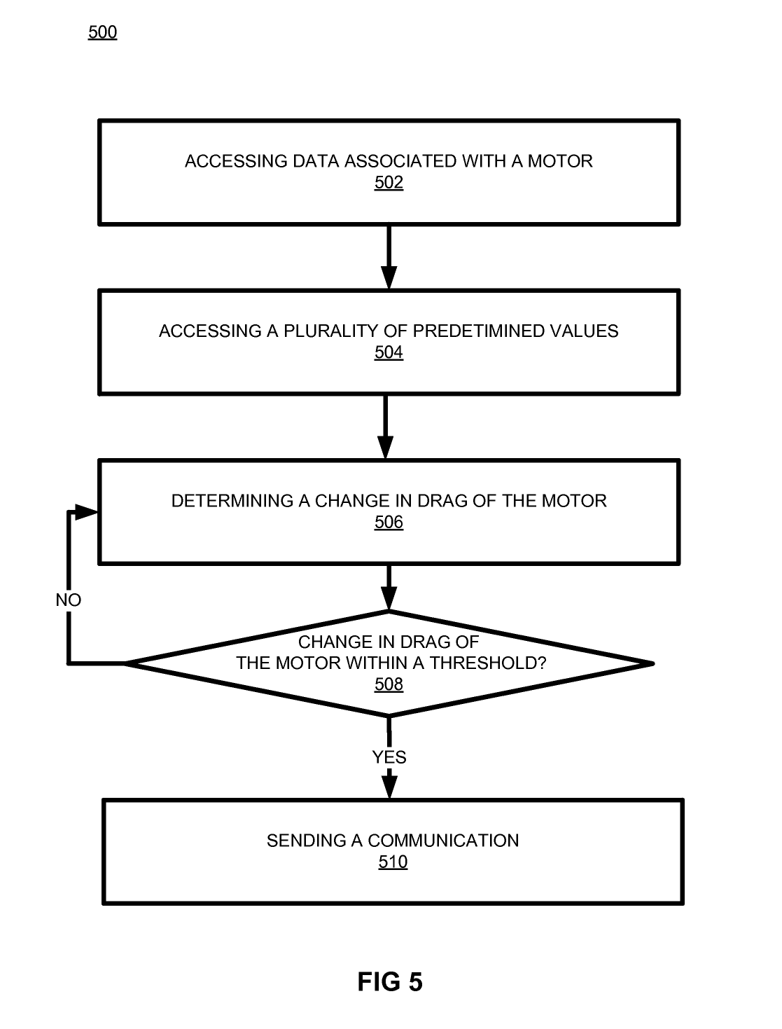

FIG. 5 provides a flow chart of a process for determining whether a drag change is within a threshold according to one aspect of the embodiments. FIG. 5 depicts a process for determining whether to send a communication based on a change in drag of a motor. For example, the communication may include a warning that failure of a motor (e.g., of a hard disk drive) is imminent or impending.

At block 502, data associated with a motor is accessed. The data may include an initial reference point temperature measurement and an initial reference point current measurement for a particular drive. For example, an initial reference point may be 20° C. or 25° C. The data may further include a recent temperature measurement and a recent current measurement.

At block 504, a plurality of predetermined values is accessed. The plurality of predetermined values may include the slope of current with respect to the temperature (e.g., c₀), the slope of the current with respect to the drag (e.g., c₁), and a constant offset (e.g., c₂). In some embodiments, the plurality of predetermined values may be associated with the motor being operated (e.g., in the field as part of a hard disk drive). In some embodiments, the plurality of predetermined values may be associated with another motor. For example, data associated with a first motor may be accessed during operation of the first motor in the field (e.g., in a hard disk drive coupled to a computing device) and the plurality of predetermined values may be associated with a second motor where the plurality of predetermined values may have been determined during manufacture and/or laboratory testing, etc. of the second motor.

At block 506, a change in drag of a motor is determined In some embodiments, the percent drag change is determined based on the equation:

$$Percent Drag change := \frac{( {K}_{I} - {K}_{I . initial} ) - ( T - {T}_{. initial} ) \cdot {c}_{1}}{{c}_{0}}$$

In various embodiments, the above equation be used based on the drive being operated at a constant speed. The K_{I.initial} and T_{.initial} may be accessed from SMART data. The K_{I} and T values may also be accessed from SMART data.

At block 508, whether the change in drag is within a threshold is determined The threshold may be a predetermined value and stored during manufacture of the storage device (e.g., in firmware or in a portion of the SMART system).

At block 510, in response to the change in drag being outside the threshold, a communication is sent. The communication may include a warning that motor or storage failure is imminent or impending.

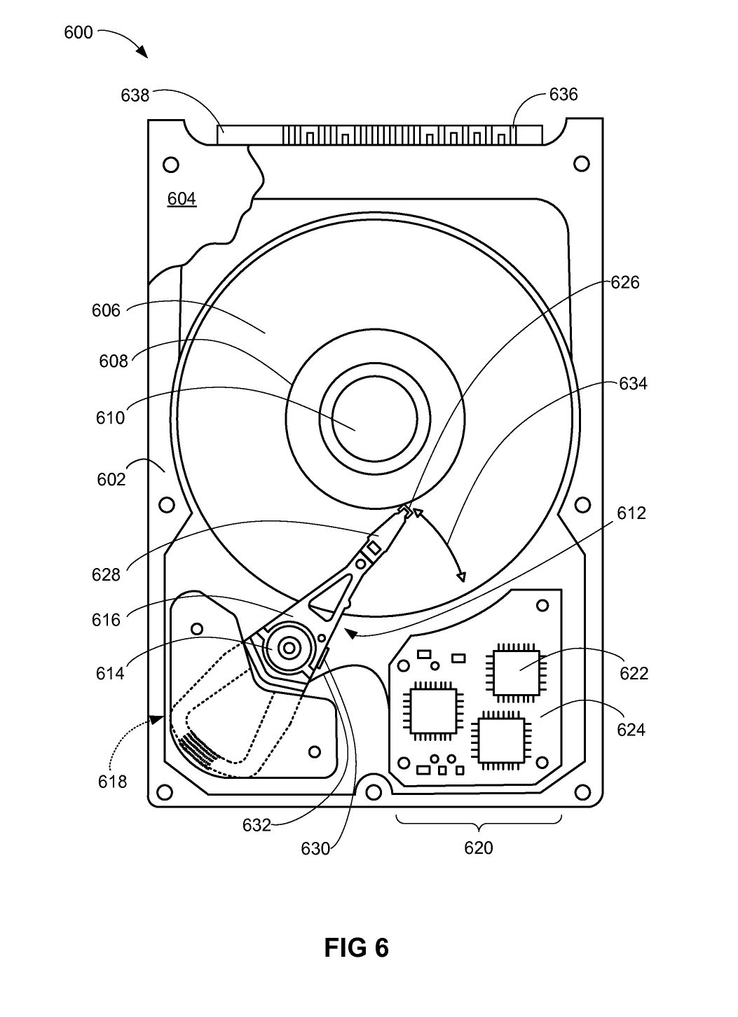

FIG. 6 illustrates an exemplary diagram of a hard drive according to one aspect of the embodiments. FIG. 6 depicts a plan view of a data storage device in which embodiments as described with respect to FIGS. 2 and 5 may be implemented is shown. A disk drive 600 generally includes a base plate 602 and a cover 604 that may be disposed on the base plate 602 to define an enclosed housing for various disk drive components. The disk drive 600 includes one or more data storage disks 606 of computer-readable data storage media. Typically, both of the major surfaces of each data storage disk 606 include a plurality of concentrically disposed tracks for data storage purposes. Each data storage disk 606 is mounted on a hub 608, which in turn is rotatably interconnected with the base plate 602 and/or cover 604. Multiple data storage disks 606 are typically mounted in vertically spaced and parallel relation on the hub 608. A spindle motor 610 rotates the data storage disks 606.

The disk drive 600 also includes an actuator arm assembly 612 that pivots about a pivot bearing 614, which in turn is rotatably supported by the base plate 602 and/or cover 604. The actuator arm assembly 612 includes one or more individual rigid actuator arms 616 that extend out from near the pivot bearing 614. Multiple actuator arms 616 are typically disposed in vertically spaced relation, with one actuator arm 616 being provided for each major data storage surface of each data storage disk 606 of the disk drive 600. Other types of actuator arm assembly configurations could be utilized as well, an example being an “E” block having one or more rigid actuator arm tips, or the like, that cantilever from a common structure. Movement of the actuator arm assembly 612 is provided by an actuator arm drive assembly, such as a voice coil motor 618 or the like. The voice coil motor 618 is a magnetic assembly that controls the operation of the actuator arm assembly 612 under the direction of control electronics 620.

The control electronics 620 may include a plurality of integrated circuits 622 coupled to a printed circuit board 624. The control electronics 620 may be coupled to the voice coil motor assembly 618, a slider 626, or the spindle motor 610 using interconnects that can include pins, cables, or wires (not shown). Plurality of integrated circuits 622 may include a processor or other component configured for performing processes 200 and 400 (e.g., see FIGS. 2 and 4). Plurality of integrated circuits 622 may further include an electronic component configured to received data (e.g., SMART data) from one or more sensors (not shown).

A load beam or suspension 628 is attached to the free end of each actuator arm 616 and cantilevers therefrom. Typically, the suspension 628 is biased generally toward its corresponding data storage disk 606 by a spring-like force. The slider 626 is disposed at or near the free end of each suspension 628. What is commonly referred to as the read/write head (e.g., transducer) is appropriately mounted as a head unit (not shown) under the slider 626 and is used in disk drive read/write operations. The head unit under the slider 626 may utilize various types of read sensor technologies such as anisotropic magnetoresistive (AMR), giant magnetoresistive (GMR), tunneling magnetoresistive (TuMR), other magnetoresistive technologies, or other suitable technologies.

The head unit under the slider 626 is connected to a preamplifier 630, which is interconnected with the control electronics 620 of the disk drive 600 by a flex cable 632 that is typically mounted on the actuator arm assembly 612. Signals are exchanged between the head unit and its corresponding data storage disk 606 for disk drive read/write operations. In this regard, the voice coil motor 618 is utilized to pivot the actuator arm assembly 612 to simultaneously move the slider 626 along a path 634 and across the corresponding data storage disk 606 to position the head unit at the appropriate position on the data storage disk 606 for disk drive read/write operations.

When the disk drive 600 is not in operation, the actuator arm assembly 612 is pivoted to a “parked position” to dispose each slider 626 generally at or beyond a perimeter of its corresponding data storage disk 606, but in any case in vertically spaced relation to its corresponding data storage disk 606. In this regard, the disk drive 600 includes a ramp assembly (not shown) that is disposed beyond a perimeter of the data storage disk 606 to both move the corresponding slider 626 vertically away from its corresponding data storage disk 606 and to also exert somewhat of a retaining force on the actuator arm assembly 612.

Exposed contacts 636 of a drive connector 638 along a side end of the disk drive 600 may be used to provide connectivity between circuitry of the disk drive 600 and a next level of integration such as an interposer, a circuit board, a cable connector, or an electronic assembly. The drive connector 638 may include jumpers (not shown) or switches (not shown) that may be used to configure the disk drive 600 for user specific features or configurations. The jumpers or switches may be recessed and exposed from within the drive connector 638.

As such, as provided herein, is a method, including accessing data associated with a motor and accessing a plurality of predetermined values associated with the motor. In some embodiments, the data associated with the motor may include temperature data and/or a value proportional to a motor electrical current. The value proportional to the motor electrical current may have been stored by a SMART (Self-Monitoring, Analysis and Reporting Technology) system. In some embodiments, a first predetermined value of the plurality of predetermined values corresponds to a rate of change of electrical current in relation to temperature. A second predetermined value of the plurality of predetermined values may correspond to a rate of change of electrical current in relation to drag. The method further includes determining a change in drag of the motor based on the data associated with the motor and the plurality of predetermined values and determining whether the change in drag of the motor is within a threshold. In response to the change in drag of the motor being outside the threshold, a communication may be sent. The communication may include an indicator that motor failure is imminent.

Also provided herein is a method, including detecting a plurality of pieces of data associated with a motor. In some embodiments, a portion of a SMART system performs the detecting of the plurality of pieces of data. The method further includes determining a percent drag change based on the plurality of pieces of data associated with the motor and determining a failure prediction of the motor based on the percent drag change. In some embodiments, the percent drag change is determined based on the plurality of pieces of data and a plurality of predetermined values associated with the motor. The plurality of predetermined values may be determined based on a plurality of spin speeds of the motor. In some embodiments, the determining of the percent drag change is based on accessing SMART data. In various embodiments, the percent drag change is based on a change in current of the motor. The method may further include determining whether the percent drag change is within a threshold and sending a signal if the percent drag change is outside of the threshold.

Also provided is an apparatus, including a motor assembly and a sensor coupled to the motor assembly, wherein the sensor is configured to collect information associated with the motor assembly. The apparatus further includes a processor configured to execute a method including accessing information collected by the sensor and determining a drag change of the motor assembly based on the information collected by the sensor. In some embodiments, the drag change is based on a value proportional to an electrical current associated with the motor assembly. In various embodiments, the determining of the drag change is based on a first electrical current of the motor assembly and a second electrical current of the motor assembly. In response to the drag change being greater than a threshold, a message about an impending failure of the motor assembly is sent. The method may further include determining a response function of the motor assembly. In some embodiments, the response function of the motor assembly is based on spin drag data and temperature data of the motor assembly data. In various embodiments, the response function of the motor assembly is determined based on a plurality of temperatures and corresponding spin drag measurements of the motor assembly. In some embodiments, the motor assembly comprises a first motor and the determining of the drag change is based a plurality of predetermined values associated with a second motor.

While particular embodiments have been described and/or illustrated, and while these embodiments and/or examples have been described in considerable detail, it is not the intention of the applicant(s) to restrict or in any way limit the scope of the concepts presented herein to such detail. Additional adaptations and/or modifications may readily appear to persons having ordinary skill in the art, and, in its broader aspects, these adaptations and/or modifications may also be encompassed. Accordingly, departures may be made from the foregoing embodiments and/or examples without departing from the scope of the concepts presented herein, which scope is limited only by the following claims when appropriately construed.

What is claimed is:

1. A method comprising:
accessing data associated with a motor;
accessing a plurality of predetermined values associated with the motor;
determining a change in drag of the motor based on the data associated with the motor and the plurality of predetermined values;
determining whether the change in drag of the motor is within a threshold; and
in response to the change in drag of the motor being outside the threshold, sending a communication.

2. The method of claim 1, wherein the data associated with the motor comprises temperature data.

3. The method of claim 1, wherein the data associated with the motor comprises a value proportional to a motor electrical current.

4. The method of claim 3, wherein the value proportional to the motor electrical current is stored by a SMART (Self-Monitoring, Analysis and Reporting Technology) system.

5. The method of claim 1, wherein the communication comprises an indicator that motor failure is imminent.

6. The method of claim 1, wherein a first predetermined value of the plurality of predetermined values corresponds to a rate of change of electrical current in relation to temperature.

7. The method of claim 1, wherein a second predetermined value of the plurality of predetermined values corresponds to a rate of change of electrical current in relation to drag.

8. A method comprising:
detecting a plurality of pieces of data associated with a motor;
determining a percent drag change based on the plurality of pieces of data associated with the motor; and
determining a failure prediction of the motor based on the percent drag change.

9. The method of claim 8, wherein a portion of a SMART system performs the detecting of the plurality of pieces of data.

10. The method of claim 8, wherein the percent drag change is determined based on the plurality of pieces of data and a plurality of predetermined values associated with the motor.

11. The method of claim 10, wherein the plurality of predetermined values are determined based on a plurality of spin speeds of the motor.

12. The method of claim 8, wherein the determining of the percent drag change is based on accessing SMART data.

13. The method of claim 8, further comprising:
determining whether the percent drag change is within a threshold; and
sending a signal if the percent drag change is outside of the threshold.

14. The method of claim 8, wherein the percent drag change is based on a change in electrical current of the motor.

15. An apparatus comprising:
a motor assembly;
a sensor coupled to the motor assembly, wherein the sensor is configured to collect information associated with the motor assembly;
a processor configured to execute a method comprising:
accessing information collected by the sensor;
determining a drag change of the motor assembly based on the information collected by the sensor;
in response to the drag change being greater than a predetermined threshold, indicating an impending failure of the motor assembly.

16. The apparatus of claim 15, wherein the drag change is based on a value proportional to an electrical current associated with the motor assembly.

17. The apparatus of claim 15, wherein the method further comprises:
determining a response function of the motor assembly.

18. The apparatus of claim 17, wherein the response function of the motor assembly is based on spin drag data and temperature data of the motor assembly data.

19. The apparatus of claim 18, wherein the response function of the motor assembly is determined based on a plurality of temperatures and corresponding spin drag measurements of the motor assembly.

20. The apparatus of claim 15, wherein the determining of the drag change is based on a first electrical current of the motor assembly and a second electrical current of the motor assembly.

21. The apparatus of claim 15, wherein the motor assembly comprises a first motor and the determining of the drag change is based a plurality of predetermined values associated with a second motor.
